(19) United States
(12) Patent Application Publication
(10) Pub. No.: US 2025/0199181 A1
(43) Pub. Date: Jun. 19, 2025

(54) REFINING DEPTH VALUES FOR TIME-OF-FLIGHT DEPTH DETECTION

(71) Applicant: QUALCOMM Incorporated, San Diego, CA (US)

(72) Inventors: Li HONG, San Diego, CA (US); Yu-Ju LIN, Hsinchu City (TW); Silei MA, Santee, CA (US)

(21) Appl. No.: 18/540,227

(22) Filed: Dec. 14, 2023

(51) Int. Cl. G01S 17/894; G06T 7/50

(52) U.S. Cl. CPC G01S 17/894; G06T 7/50

(57) ABSTRACT

Systems and techniques are described herein for refining depth values. For instance, a method for refining depth values is provided. The method may include obtaining a depth representation of a scene, the depth representation comprising depth values based on a time-of-flight (ToF) signal; obtaining amplitude values corresponding to the depth values of the depth representation, wherein the amplitude values are based on the ToF signal; generating a peak map based on the amplitude values and the depth values; generating a depth-based mask based on the depth values; and generating refined depth values based on the depth values, the peak map, and the depth-based mask.

### TECHNICAL FIELD

The present disclosure generally relates to depth determination. For example, aspects of the present disclosure include systems and techniques for refining depth values for time-of-flight depth-detection techniques (e.g., sparse time-of-flight depth-detection techniques).

### BACKGROUND

A direct Time-of-Flight (dToF) depth camera may measure a timing difference (e.g., a time of flight) between when a light pulse is emitted and when the light pulse is received by the dToF depth camera (e.g., after the light pulse has been reflected by an object in the environment). The dToF depth camera may, based on the time of flight and the speed of light, calculate a distance between the dToF depth camera and the object in the environment.

An indirect Time-of-Flight (iToF) depth camera may measure a phase difference between an emitted light pulse and the light pulse as received by the iToF depth camera after the light pulse has been reflected by an object in the environment. The iToF depth camera may relate the phase difference to a time of flight of the light pulse between emission and reception, based on the speed of light and the frequency of the light pulse. The iToF depth camera may, based on the time of flight and the speed of light, calculate a distance between the iToF depth camera and the object in the environment.

A depth camera (e.g., either a dToF depth camera or an iToF depth camera) may emit one more light pulses into an environment and determine depth information relative to the environment. For example, the depth camera may emit one or more light pulses and receive and focus reflected light pulses onto an array of sensors. Using the array of sensors, the depth camera may determine depths for each of a number of points within a field of view of the depth camera. The number of depths may be a depth representation of the environment.

A sparse ToF depth camera may emit fewer light pulses into the environment than the number of individual photodetectors of the array of sensors of the sparse ToF depth camera. For example, the sparse ToF depth camera may include a million or more individual photodetectors arranged in an array (e.g., in an array of 1920×1080 individual photodetectors). However the sparse ToF depth camera may project tens of thousands of light pulses into the environment (e.g., a pattern of 200×200 individual dots).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for refining depth values. According to at least one example, a method is provided for refining depth values. The method includes: obtaining a depth representation of a scene, the depth representation comprising depth values based on a time-of-flight (ToF) signal; obtaining amplitude values corresponding to the depth values of the depth representation, wherein the amplitude values are based on the ToF signal; generating a peak map based on the amplitude values and the depth values; generating a depth-based mask based on the depth values; and generating refined depth values based on the depth values, the peak map, and the depth-based mask.

In another example, an apparatus for refining depth values is provided that includes at least one memory and at least one processor (e.g., configured in circuitry) coupled to the at least one memory. The at least one processor configured to: obtain a depth representation of a scene, the depth representation comprising depth values based on a time-of-flight (ToF) signal; obtain amplitude values corresponding to the depth values of the depth representation, wherein the amplitude values are based on the ToF signal; generate a peak map based on the amplitude values and the depth values; generate a depth-based mask based on the depth values; and generate refined depth values based on the depth values, the peak map, and the depth-based mask.

In another example, a non-transitory computer-readable medium is provided that has stored thereon instructions that, when executed by one or more processors, cause the one or more processors to: obtain a depth representation of a scene, the depth representation comprising depth values based on a time-of-flight (ToF) signal; obtain amplitude values corresponding to the depth values of the depth representation, wherein the amplitude values are based on the ToF signal; generate a peak map based on the amplitude values and the depth values; generate a depth-based mask based on the depth values; and generate refined depth values based on the depth values, the peak map, and the depth-based mask.

In another example, an apparatus for refining depth values is provided. The apparatus includes: means for obtaining a depth representation of a scene, the depth representation comprising depth values based on a time-of-flight (ToF) signal; means for obtaining amplitude values corresponding to the depth values of the depth representation, wherein the amplitude values are based on the ToF signal; means for generating a peak map based on the amplitude values and the depth values; means for generating a depth-based mask based on the depth values; and means for generating refined depth values based on the depth values, the peak map, and the depth-based mask.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example time of flight (ToF) camera, according to various aspects of the present disclosure;

FIG. 2 is a diagram illustrating an example sparse ToF depth camera, according to various aspects of the present disclosure;

FIG. 3A is a diagram illustrating an example system for refining depth values, according to various aspects of the present disclosure;

FIG. 3B is a block diagram illustrating the system of FIG. 3A with additional modules enabled, according to various aspects of the present disclosure;

FIG. 4A is a block diagram illustrating an example local amplitude peak detector that may determine a peak map based on amplitude values 302 and depth values 304, according to various aspects of the present disclosure;

FIG. 4B includes representations of various maps and mask used by various systems and techniques, according to various aspects of the present disclosure;

FIG. 5 is a block diagram illustrating an example peak detector that may generate amplitude-based map based on amplitude values, according to various aspects of the present disclosure;

FIG. 6 is a block diagram illustrating an example spot checker that may generate a peak map based on a peak map, according to various aspects of the present disclosure;

FIG. 7 is a block diagram illustrating an example depth noise analyzer that may generate depth-based mask based on depth values, according to various aspects of the present disclosure;

FIG. 8 is a block diagram illustrating an example combiner that may combine peak map and depth noise analyzer to generate combined mask and apply combined mask to depth values to determine refined depth values, according to various aspects of the present disclosure;

FIG. 9 is a flow diagram illustrating another example process for refining depth values, in accordance with aspects of the present disclosure;

FIG. 10 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, a time-of-flight (ToF) depth camera may project light into a scene and capture reflections of the light at an array of photodetectors. For each photodetector of the array of photodetectors, the ToF depth camera may determine a time of flight of the light between when the light is projected and when the light is captured at the array of photodetectors. Based on the time of flight of the light as received at the array of photodetectors, the ToF depth camera may generate a depth representation of the scene comprised of depth values. The depth representation of the scene may be referred to as a depth map. The depth map may include depth values arranged as depth pixels of the depth map. The depth map may include one depth pixel for each photodetector of the array of photodetectors.

A sparse ToF depth camera may project patterned light into the scene. For example, the sparse ToF depth camera may project a pattern of dots of light. The pattern may be generated, for example, using a diffractive optical element (DOE). In the present disclosure, the term “dots” may be used to refer to elements of a pattern that may be used when projecting light. For simplicity, the term “dots” may also be used to refer to the light as projected and/or as reflected. For example, a sparse ToF depth camera may project dots and an array of photodetectors of the sparse ToF depth camera may measure the dots.

A sparse ToF depth camera may project fewer dots than the number of photodetectors of the array of photodetectors. For example, the sparse ToF depth camera may include a million or more individual photodetectors arranged in an array (e.g., in an array of 1920×1080 individual photodetectors). However the sparse ToF depth camera may project tens of thousands of dots into the environment (e.g., a pattern of 400×400 individual dots). The dots may register as “spots” in a depth map. For example, a dot, as projected and reflected, may be captured by a number of photodetectors as a number of depth values. The number of depth values may be referred to, collectively, as a “spot.” For example, the sparse ToF depth camera may project a dot into the scene. The dot may be reflected and received at a group (e.g., a 7×7 group) of photodetectors. All of the photodetectors group of photodetectors may store depth values based on the dot. The depth values based on the dot may be a spot.

A depth map may include one depth value per photodetector (of which there may be a million, for example) but only one spot per dot of the pattern of dots (of which there may be tens of thousands, for example). Each dot may correspond to only one depth in the scene. Thus, each depth value of a given spot may represent the same depth. Further, depth values that do not represent dots (e.g., depth values between dots) may not provide useful depth information as such depth values may be based on noise and/or multi-path interference. It may be advantageous for a sparse ToF depth camera to store only one depth value per dot. For example, storing one depth value per dot may conserve bandwidth when the depth map is communicated and/or may conserve computational resources when the depth map is used. Further, because each spot corresponds to a single dot, which has a single depth in the scene, storing one depth value per dot may not result in a loss of significant depth information.

It may be important to accurately identify which depth value of a spot to store as the depth value of the spot. For example, if a dot resulted in a spot that includes a 7×7 group of depth values, it may be important to select an accurate depth value to store to represent the depth of the point in the scene that reflected the dot. For instance, to generate an accurate depth map, it may be important to accurately select depth values of spots.

Systems, apparatuses, methods (also referred to as processes), and computer-readable media (collectively referred to herein as “systems and techniques”) are described herein for refining depth values, such as for ToF depth-detection techniques (e.g., sparse time-of-flight depth-detection techniques). For example, the systems and techniques described herein may obtain a number of depth values (e.g., ToF depth values) and a number of corresponding amplitude values. The systems and techniques may determine a subset of the depth values to store as refined depth values (e.g., a refined depth map) based on the depth values and based on the amplitude values. The refined depth values may be a depth representation of the scene including fewer depth values than the initial number of depth values. The refined depth values may represent spots using fewer depth values than the number of depth values used to represent the spots in the initial number of depth values. For example, refined depth values may represent each spot with one respective depth value (or none).

For example, the systems and techniques generate a peak map based on the amplitude values and the depth values. The peak map may indicate peak amplitudes of spots. For example, the peak map may indicate the depth values of spots that correspond to the greatest amplitude values. The depth value of a spot that corresponds to the greatest amplitude value may be the most accurate depth value to use to represent the spot. For example, the depth value that corresponds to the peak amplitude value may be a center of the reflection of the spot. The center of the reflection may result in the most accurate depth measurement for the spot.

Further, the systems and techniques may determine a depth-based mask based on the depth values. The depth-based mask may be based on a variability of depth values. Depth values that are in regions of high variability may be the result of noise. A region of noisy depth values may be unreliable. Accordingly the depth-based mask may indicate noisy and unreliable regions of a depth map. The systems and techniques may use the peak map and the depth-based mask to determine which depth values of the obtained depth values to retain as the refined depth values of the refined depth map.

Various aspects of the application will be described with respect to the figures below.

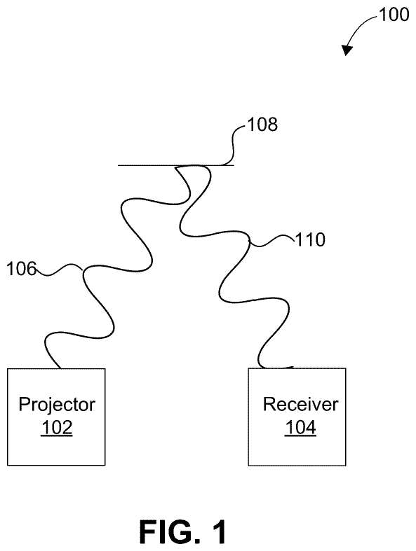

FIG. 1 is a diagram illustrating an example time of flight (ToF) camera 100, according to various aspects of the present disclosure. ToF camera 100 may be a direct Time-of-Flight (dToF) depth camera or an indirect Time-of-Flight (iToF) depth camera.

As a dToF depth camera, ToF camera 100 may measure a timing difference (e.g., a time of flight) between when emitted light pulse 106 is emitted by projector 102 and when reflected light pulse 110 received by receiver 104 (e.g., after emitted light pulse 106 has been reflected by or off of object 108 in an environment). Although illustrated as spread apart in FIG. 1, projector 102 and receiver 104 may be collocated, beside one another, or interspersed with one another. As a dToF depth camera, ToF camera 100 may, based on the time of flight and the speed of light, calculate a distance between the dToF depth camera and object 108 in the environment.

As an iToF depth camera, ToF camera 100 may measure a phase difference between emitted light pulse 106 as emitted by projector 102 and reflected light pulse 110 as received by receiver 104. ToF camera 100 may relate the phase difference to a time of flight of emitted light pulse 106 between emission and reception, based on the speed of light and the frequency of the light pulse. As an iToF depth camera, ToF camera 100 may, based on the time of flight and the speed of light, calculate a distance between the iToF depth camera and object 108 in the environment.

ToF camera 100 (as either a dToF depth camera or an iToF depth camera) may emit one more light pulses into the environment and determine depth information relative to the environment. For example, the depth camera may emit one or more light pulses (from projector 102) and receive and focus reflected light pulses onto an array of sensors (of receiver 104). Using the array of sensors, the depth camera may determine depths for each of a number of points within a field of view of the depth camera. The number of depths may be a depth representation of the environment.

In the present disclosure, the term “light” may be used to refer to any portion of the electromagnetic spectrum. For example, light may refer to visible light, infrared light (IR), ultraviolet light (UV), or other portions of the electromagnetic spectrum.

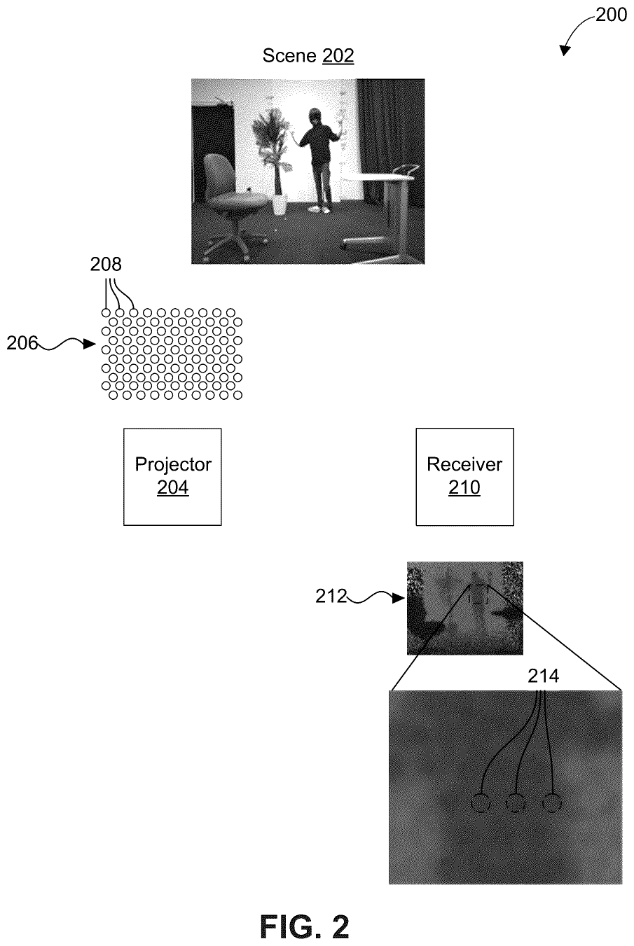

FIG. 2 is a diagram illustrating an example sparse ToF depth camera 200, according to various aspects of the present disclosure. Sparse ToF depth camera 200 may be an iToF depth camera. Projector 204 may project light in a pattern 206 of dots 208 into scene 202. Receiver 210 may receive light as reflected by the scene and sparse ToF depth camera 200 may generate depth map 212 based on the received light. Depth map 212 may include a number of depth values, for example, one depth value for each photodetector of receiver 210. Depth map 212 may include spots 214. Each of spots 214 may correspond to one of dots 208. Each of spots 214 may be made up of multiple depth values of depth map 212. As will be described in further detail below, the systems and techniques may determine refined depth values. The refined depth values may include fewer depth values than the number of depth values of depth map 212. For example, the systems and techniques may determine one depth pixel (or none) to represent each spot in depth map 212.

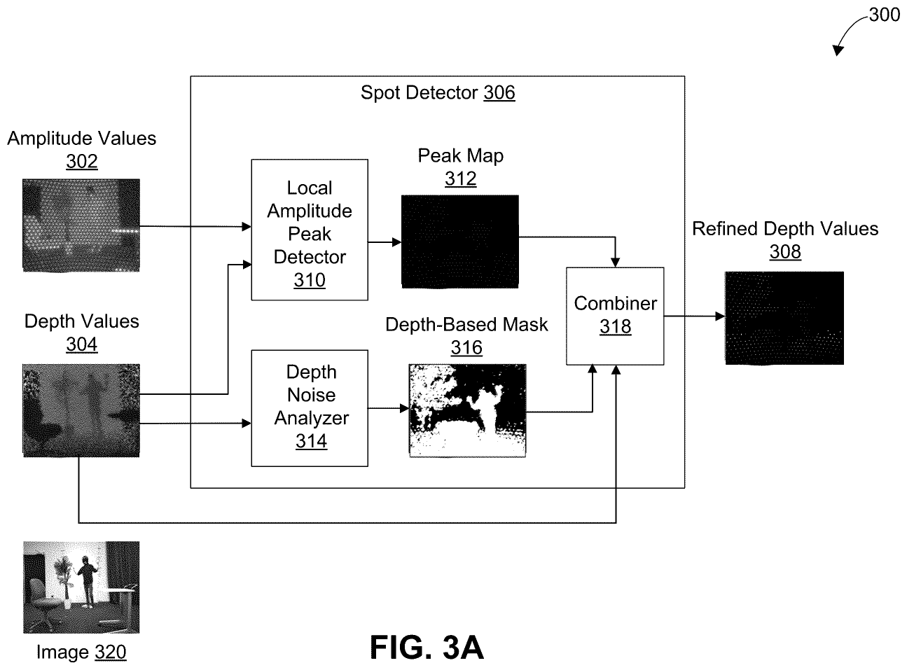

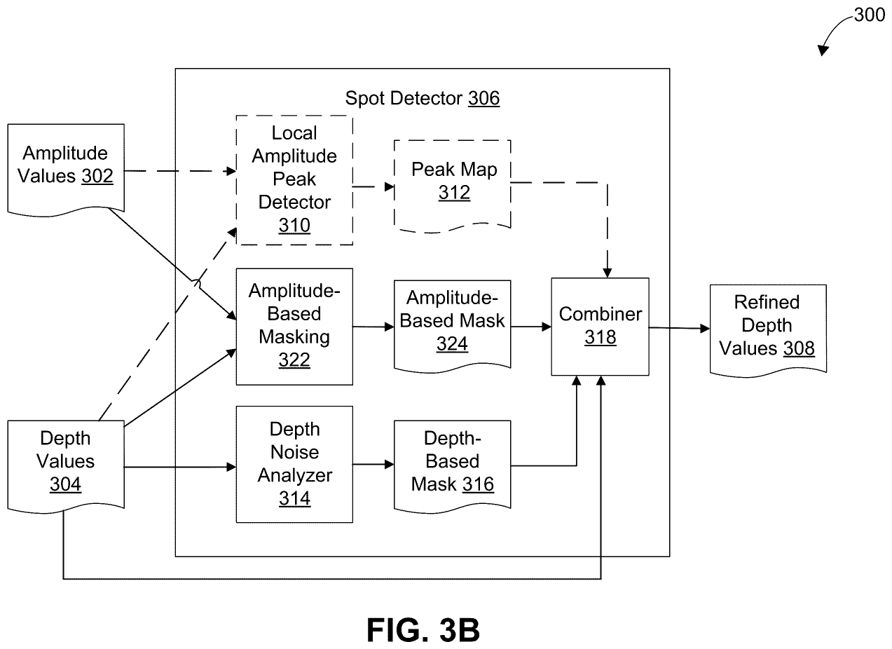

FIG. 3A is a diagram illustrating an example system 300 for refining depth values, according to various aspects of the present disclosure. For example, spot detector 306 may generate refined depth values 308 based on amplitude values 302 and depth values 304. In further detail, local amplitude peak detector 310 of spot detector 306 may determine peak map 312 based on amplitude values 302 and depth values 304. Further, depth noise analyzer 314 of spot detector 306 may generate a depth-based mask 316 based on depth values 304. Combiner 318 of spot detector 306 may combine peak map 312 and depth-based mask 316 and apply the combined peak map 312 and depth-based mask 316 to depth values 304 to generate refined depth values 308.

Depth values 304 includes a number of depth values determined based on a time of flight (ToF) signal projected into a scene and reflected from the scene. Depth values 304 may be a depth representation of the scene. Depth values 304 may be an example of depth map 212 of FIG. 2. Depth values 304 is illustrated with light pixel values representing deep depths and dark pixels representing close depths.

Amplitude values 302 includes a number of amplitude values determined based on the ToF signal. In particular, whereas amplitude values 302 is determined based on the timing of the reflected ToF signal, depth values 304 is based on an amplitude of the reflected ToF signal. For example, sparse ToF depth camera 200 may determine a timing of the ToF signal at each photodetector (e.g., of receiver 210) and determine depth values 304 based on the timings. Further, sparse ToF depth camera 200 may measure an amplitude of the return signal at each photodetector. The amplitudes may be arranged as amplitude values 302. Each of amplitude values 302 may correspond to one of depth values 304. For example, a photodetector may receive a return ToF signal, record an amplitude value of amplitude values 302 and record a timing of the return ToF signal. Sparse ToF depth camera 200 may determine a depth of depth values 304 based on the timing. Amplitude values 302 is illustrated with light pixels representing strong return signals and dark pixels representing weak return signals.

Image 320 is a color image of the scene from which amplitude values 302 and depth values 304 are generated. Image 320 may not be used by spot detector 306 and is presented to aid in understanding.

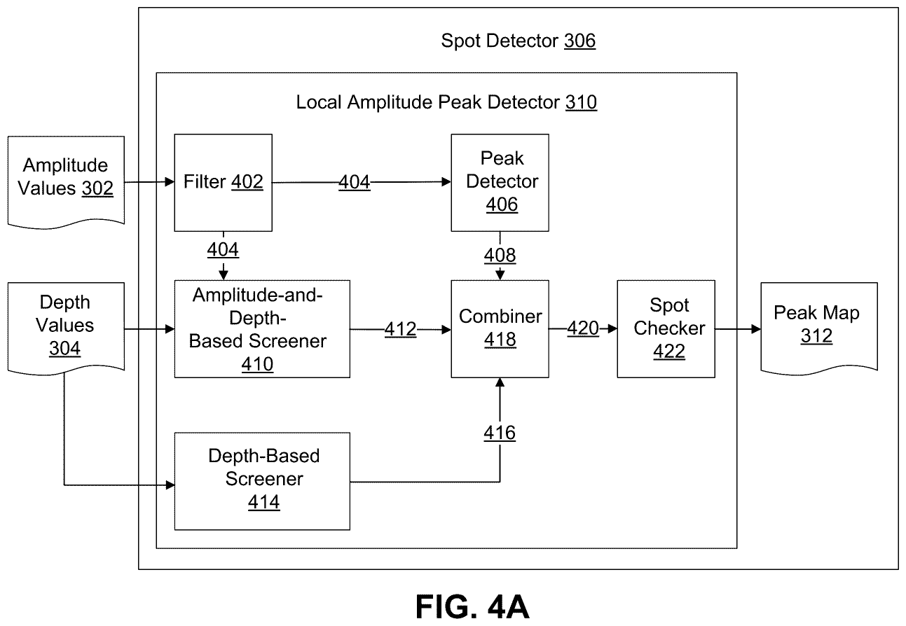

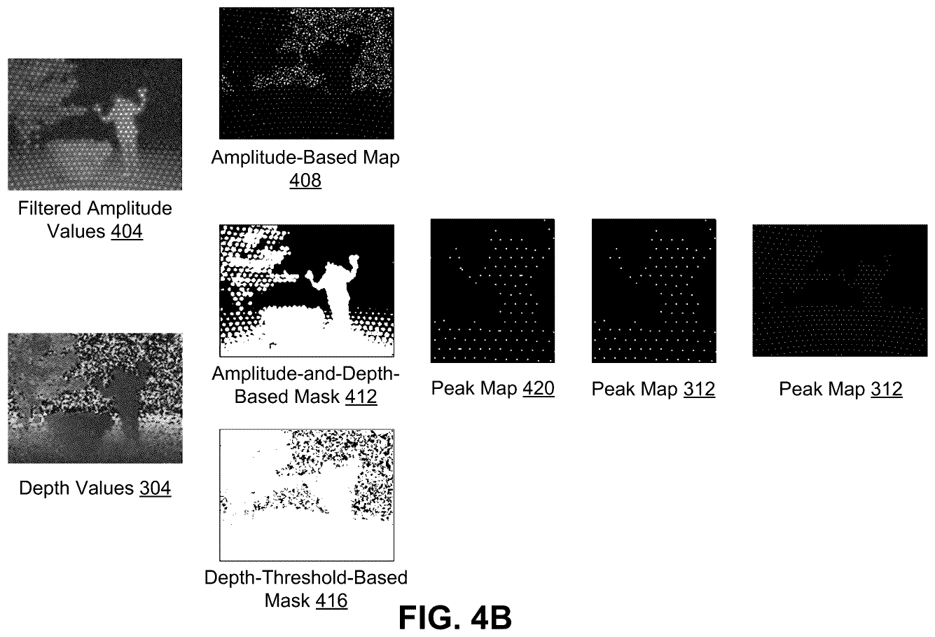

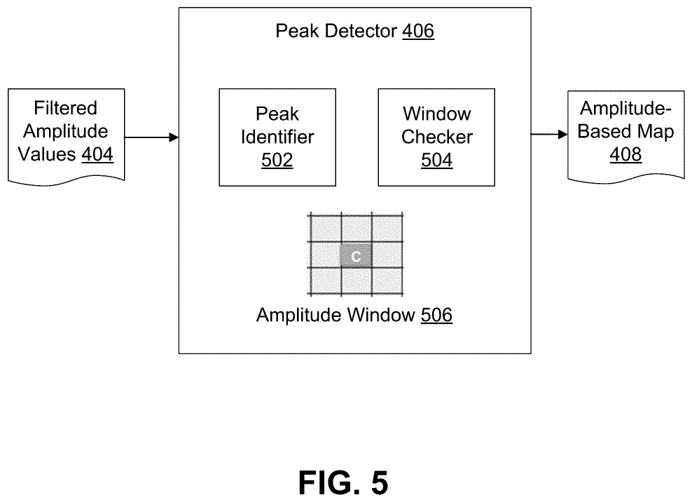

Local amplitude peak detector 310 may generate peak map 312 based on amplitude values 302 and depth values 304. Peak map 312 may include one depth value (or indication of a depth value) per spot. For example, in some cases, peak map 312 may include depth values of depth values 304. In other cases, peak map 312 may be a mask indicating locations of valid ones of depth values 304. Peak map 312 is illustrated with light pixels indicating valid depth values. Local amplitude peak detector 310 may determine a one depth value of depth values 304 to represent each spot. For example, for each spot, local amplitude peak detector 310 may include a depth value that corresponds to a peak amplitude value. The peak amplitude value may correspond to a depth value that has a high chance of being an accurate depth value for the spot. FIG. 4A, FIG. 4B, and FIG. 5 provide additional detail regarding local amplitude peak detector 310.

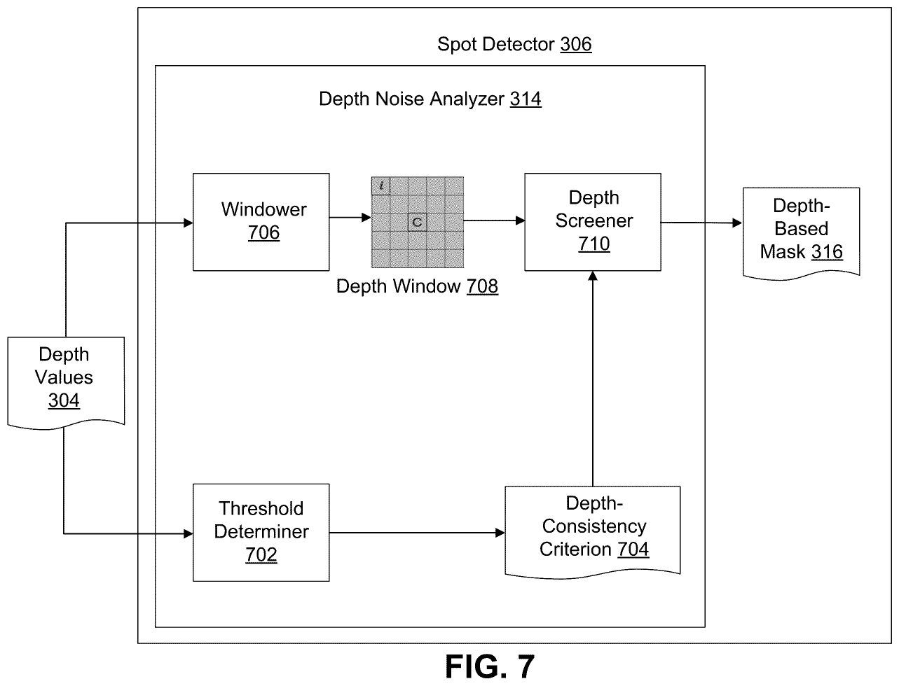

Depth noise analyzer 314 may generate depth-based mask 316 based on depth values 304. Depth-based mask 316 may indicate which of depth values 304 are valid and which are not. Depth-based mask 316 is illustrated with white pixels indicating valid pixels and black pixels indicating invalid pixels. Depth-based mask 316 may determine which depth values of depth values 304 are valid based on noise in depth values 304. For example, noisy regions of depth values 304 (which appear as speckled based on a variety of depth values within the noisy region) may be invalid in depth-based mask 316. FIG. 7 provides additional detail regarding depth noise analyzer 314.

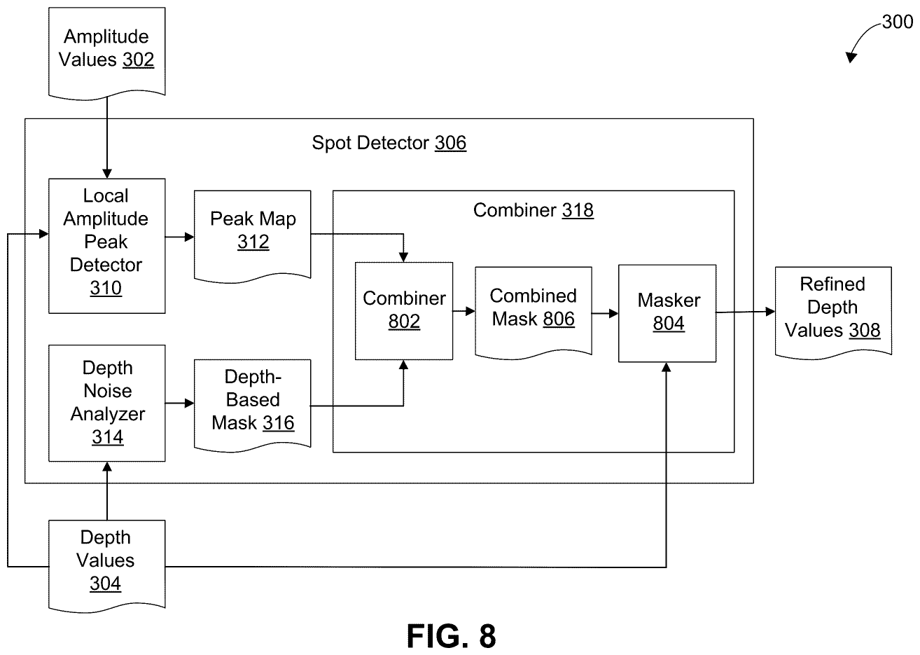

Combiner 318 may combine peak map 312 and depth-based mask 316 and apply the combined peak map 312 and depth-based mask 316 to depth values 304 to generate refined depth values 308. FIG. 8 provides additional detail regarding combiner 318.

FIG. 3B is a block diagram illustrating system 300 with additional modules enabled, and with some modules of system 300 disabled, according to various aspects of the present disclosure. In system 300, as illustrated in FIG. 3B, amplitude-based masking 322 is enabled and local amplitude peak detector 310 is disabled (which is illustrated by local amplitude peak detector 310 and peak map 312 being illustrated using dashed lines). Amplitude-based masking 322 generates amplitude-based mask 324 based on amplitude values 302 and depth values 304. Amplitude-based masking 322 may be used when system 300 processes full-field ToF data. For example, when system 300 processes full-field ToF data (rather than sparse ToF data), system 300 may use amplitude-based masking 322 to generate amplitude-based mask 324 based on amplitude values 302 and depth values 304. In such cases, combiner 318 may combine amplitude-based mask 324 and depth-based mask 316 then apply the combination of amplitude-based mask 324 and depth-based mask 316 to depth values 304 to generate refined depth values 308.

In general, amplitude-based masking 322 may generate amplitude-based mask 324 based on amplitude values 302 and depth values 304. Amplitude-based mask 324 may indicate which of depth values 304 are valid or invalid. Amplitude-based masking 322 may determine amplitude-based mask 324 at least partially based on a predetermined relationship between amplitude and depth.

FIG. 4A is a block diagram illustrating an example local amplitude peak detector 310 that may determine peak map 312 based on amplitude values 302 and depth values 304, according to various aspects of the present disclosure. Local amplitude peak detector 310 is illustrated in FIG. 4A to provide additional detail regarding the operation of local amplitude peak detector 310 (which was introduced in FIG. 3A).

Local amplitude peak detector 310 may, or may not, include a filter 402. Filter 402 may filter amplitude values 302 to generate filtered amplitude values 404, for example, to remove outliers or to smooth amplitude values 302. Filtered amplitude values 404 of FIG. 4B illustrates an example of how filtered amplitude values 404 may appear if rendered. Returning to FIG. 4A, filter 402 is optional in local amplitude peak detector 310. In cases in which filter 402 is not included in local amplitude peak detector 310, local amplitude peak detector 310 may use amplitude values 302 in place of filtered amplitude values 404.

Peak detector 406 of local amplitude peak detector 310 may detect peak amplitude values of amplitude values 302 and generates amplitude-based map 408 based on the peak amplitude values. In the present disclosure, the term “peak” may refer to the greatest value of a number of values. For example, a peak may be the greatest amplitude value of a window of amplitude values. The window of amplitude values may represent a spot. Thus, a peak amplitude value may represent the greatest amplitude value of a spot and peak detector 406 may detect peaks of spots. Peak detector 406 may generate amplitude-based map 408 to be indicative of peaks of spots. Amplitude-based map 408 of FIG. 4B illustrates an example of how amplitude-based map 408 may appear if rendered. FIG. 5 includes additional detail regarding peak detector 406.

Returning to FIG. 4A, depth-based screener 414 of local amplitude peak detector 310 may generate depth-threshold-based mask 416 based on depth values 304 and a depth threshold. For example, a depth sensor which generated depth values 304 (e.g., sparse ToF depth camera 200) may have a predetermined depth range for which the sensor can generate valid depth values. For example, the sensor may generate valid depth values for points of a scene that are between 1 meter and 20 meters from the sensor and invalid depth value for points that are closer than 1 meter or farther than 20 meters from the sensor. The depth threshold may be predetermined, for example, to reflect known characteristics (e.g., limitations) of the depth sensor which generated depth values 304. Depth-based screener 414 may generate depth-threshold-based mask 416, based on the depth threshold, to indicate which of depth values 304 are valid (or invalid) based on the depth threshold. Depth-threshold-based mask 416 of FIG. 4B illustrates an example of how depth-threshold-based mask 416 may appear if rendered.

Returning to FIG. 4A, similar to depth-based screener 414, amplitude-and-depth-based screener 410 may generate amplitude-and-depth-based mask 412 based on depth values 304 and a depth threshold. However, the depth threshold used by depth-based screener 414 may be determined on a depth-value-by-depth-value basis based on corresponding amplitude values whereas the depth threshold used by depth-based screener 414 may be uniformly applicable to all of depth values 304. For example, there may be a relationship between depth values and amplitude values. For instance, close points in a scene may reflect ToF signals with a greater signal strength than distant points in the scene. For example, a point 2 meters from a depth sensor may result in a return ToF signal with a greater signal strength than a point 20 meters from the depth sensor. Thus, close depth values may correspond to greater amplitude values. Accordingly, a relationship between amplitude values and depth values may be determined. The relationship may include valid depth values for a given amplitude value and/or valid amplitude values for a given depth value. The relationship may be stored, for example, in a lookup table (LUT). The relationship may be used as an amplitude-based depth threshold.

For example, amplitude-and-depth-based screener 410 may obtain an amplitude value corresponding to a given depth value. Amplitude-and-depth-based screener 410 may determine an amplitude-based depth threshold based on the amplitude value and the relationship. The amplitude-based depth threshold may indicate a range of valid depths that may correspond to the amplitude value. Amplitude-and-depth-based screener 410 may compare the given depth value with the amplitude-based depth threshold to determine whether the given depth value is valid and generate a value of amplitude-and-depth-based mask 412 corresponding to the given depth value based on whether the given depth value is valid or not. Amplitude-and-depth-based mask 412 of FIG. 4B illustrates an example of how amplitude-and-depth-based mask 412 may appear if rendered.

Returning to FIG. 4A, combiner 418 may combine amplitude-based map 408, amplitude-and-depth-based mask 412, and depth-threshold-based mask 416 to generate peak map 420. As mentioned above, amplitude-based map 408 may indicate peaks of windows (which may correspond to spots), amplitude-and-depth-based mask 412 and depth-threshold-based mask 416 may indicate which of depth values 304 are valid (or invalid). In combining amplitude-and-depth-based mask 412, and depth-threshold-based mask 416, combiner 418 may determine that any depth value that is indicated as invalid in either amplitude-and-depth-based mask 412 or combiner 418 is invalid. Further, combiner 418 may select the valid depth values (as indicated by amplitude-and-depth-based mask 412 and depth-threshold-based mask 416) indicated by amplitude-based map 408. As such, peak map 420 may include a map of valid peaks (e.g., having the invalid peaks, as indicated by amplitude-and-depth-based mask 412 and/or depth-threshold-based mask 416) removed.

Peak map 420 of FIG. 4B illustrates an example of how a cropped portion of peak map 420 may appear if rendered. It is worth noting in the cropped portion of peak map 420 as illustrated in FIG. 4B, there are several instances of multiple peaks in close proximity. For example, peak map 420 may include an indication of more than one depth value per spot. Peak detector 406 may identify peaks within windows. Peak detector 406 may select the window size to correspond to a size of a dot. However, in some cases, peak detector 406 may identify multiple peaks that correspond to a single spot.

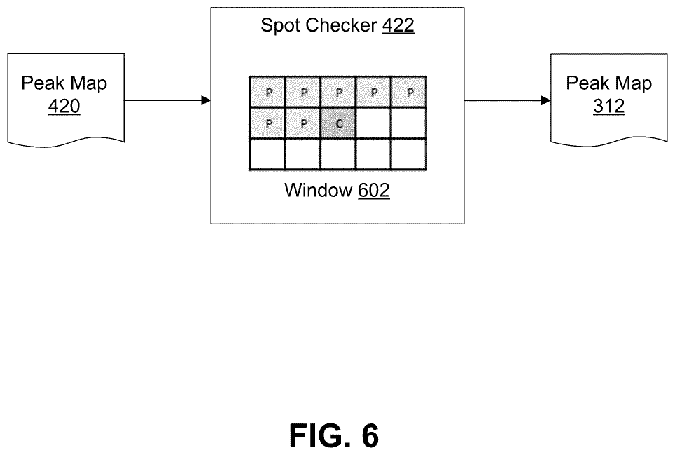

Returning to FIG. 4A, spot checker 422 may refine peak map 420 to generate peak map 312 such that peak map 312 does not include multiple depth values within a window of each other. The window may be selected to remove instances of multiple depth pixels of peak map 312 corresponding to a single dot. Additional detail regarding spot checker 422 is provided with regard to FIG. 6.

FIG. 4B includes two representations of peak map 312. A first representation is cropped and zoomed to correspond to the cropped portion of peak map 420 to illustrate that peak map 312 does not include multiple depth values per spot. The second representation is zoomed to correspond to the size of others of the representations of FIG. 4B.

FIG. 5 is a block diagram illustrating an example peak detector 406 that may generate amplitude-based map 408 based on filtered amplitude values 404 (or amplitude values 302 in cases in which local amplitude peak detector 310 omits filter 402), according to various aspects of the present disclosure. Peak detector 406 is illustrated in FIG. 5 to provide additional detail regarding the operation of peak detector 406 (which was introduced in FIG. 4A).

Peak detector 406 may divide filtered amplitude values 404 into a number of amplitude windows 506. Each of amplitude windows 506 may include a center amplitude value (c) and a number of neighboring values. In some cases, peak detector 406 may divide filtered amplitude values 404 into amplitude windows 506 by dividing filtered amplitude values 404 according to a grid. In other cases, peak detector 406 may generate amplitude windows 506 by sliding a window across filtered amplitude values 404.

Window checker 504 of peak detector 406 may identify amplitude windows 506 that satisfy a window-amplitude criterion. For example, window checker 504 may determine whether a sum of all amplitude values of a given window satisfy the window-amplitude criterion (e.g., whether the sum is greater than a threshold). Amplitude values that together are not greater than a threshold may be too weak to consider and may not be identified by window checker 504. For example, valid spots may correspond to strong ToF returns within a group of amplitude values. Windows of weak ToF returns may not correspond to spots. Thus, window checker 504 may identify spots by identifying amplitude windows 506.

Peak identifier 502 of peak detector 406 may identify a peak pixel of amplitude windows 506. For example, for each of amplitude windows 506 of filtered amplitude values 404, peak identifier 502 may identify a peak amplitude value (e.g., the greatest amplitude value of the amplitude window 506).

Peak detector 406 may determine that each peak amplitude value of each amplitude window 506 that satisfies the window-amplitude criterion is a candidate peak and store an indication of the candidate peaks in amplitude-based map 408.

FIG. 6 is a block diagram illustrating an example spot checker 422 that may generate peak map 312 based on peak map 420, according to various aspects of the present disclosure. Spot checker 422 is illustrated in FIG. 6 to provide additional detail regarding the operation of spot checker 422 (which was introduced in FIG. 4A).

Spot checker 422 may select one peak per window 602 such that peak map 312 includes one peak per window. For example, in some aspects, spot checker 422 may divide peak map 420 according to a grid to generate a number of window 602. Further, spot checker 422 may select no more than one peak of peak map 420 for each of the number of windows 602. As another example, spot checker 422 may slide window 602 through peak map 420 and select one peak per window 602. As another example, spot checker 422 may operate as peak detector 406 is detecting peaks to cause peak detector 406 to identify no more than one peak per window 602. For example, spot checker 422 may determine when peak detector 406 has detected a peak and may cause peak detector 406 to skip a remainder of a current window 602 such that peak detector 406 does not identify more than one peak per window 602.

FIG. 7 is a block diagram illustrating an example depth noise analyzer 314 that may generate depth-based mask 316 based on depth values 304, according to various aspects of the present disclosure. Depth noise analyzer 314 is illustrated in FIG. 7 to provide additional detail regarding the operation of depth noise analyzer 314 (which was introduced in FIG. 3A).

There may be a relationship between depth and variability in depth values. For example, the farther away from a depth sensor that points in a scene are, the more variability there may be in depth values from that point in the scene. For example, a dot projected 2 meters into a scene may result in a spot with a first degree of variability in the depth values of the spot and a dot that is projected 20 meters into the scene may result in a spot with a second degree of variability that is greater than the first degree of variability. Threshold determiner 702 may determine a depth-consistency criterion 704 for each depth values 304 based on depth values 304. For example, for a given depth value of depth values 304, threshold determiner 702 may determine a depth-consistency criterion 704.

Windower 706 may divide depth values 304 into a number of depth windows 708. For example, windower 706 may divide depth values 304 into depth windows 708 according to a grid. As another example, windower 706 may slide depth window 708 across depth values 304 to generate the number of depth windows 708.

Depth screener 710 may determine which of depth windows 708 satisfy a depth-consistency criterion 704. As mentioned above, there may be a depth-consistency criterion 704 for each depth values 304. So, depth screener 710 may determine which of depth window 708 satisfy the depth-consistency criterion 704 corresponding to the center depth value of the depth window 708. For example, for a given depth window 708, with a center depth value (c), depth screener 710 may obtain a depth-consistency criterion 704 from threshold determiner 702. Depth screener 710 may determine whether the given depth window 708 satisfies the depth-consistency criterion 704.

Depth-consistency criterion 704 may relate to how many depth values of a depth window 708 are within a threshold depth from the center depth value (c) of the depth window 708. For example, depth-consistency criterion 704 may indicate a number of depth values of a depth window 708 must be within a threshold depth from (c) satisfy the depth-consistency criterion 704.

For example, for a given depth value (c) (e.g., 20 meters) of a given depth window 708, a depth-consistency criterion 704 may indicate that 18 out of 24 neighboring depth values of the given depth window 708 must be within 1 meter of the given depth value (c). Accordingly if 18 or more of the neighboring depth values of the given depth window 708 are between 19 and 21 meters, the given depth window 708 may satisfy the depth-consistency criterion 704. As another example, for a given depth value (c) (e.g., 2 meters) of a given depth window 708, a depth-consistency criterion 704 may indicate that 18 out of 24 neighboring depth values of the given depth window 708 must be within 0.20 meters of the given depth value (c). Accordingly if 18 or more of the neighboring depth values of the given depth window 708 are between 1.8 and 2.2 meters, the given depth window 708 may satisfy the depth-consistency criterion 704.

Depth noise analyzer 314 may generate depth-based mask 316 to indicate which of depth values 304 are center values of a depth window 708 that satisfies a depth-consistency criterion 704. As such depth-based mask 316 may indicate which depth values 304 are the center of a window that satisfies a depth-consistency criterion 704.

FIG. 8 is a block diagram illustrating an example combiner 318 that may combine peak map 312 and depth noise analyzer 314 to generate combined mask 806 and apply combined mask 806 to depth values 304 to determine refined depth values 308, according to various aspects of the present disclosure. Combiner 318 is illustrated in FIG. 8 to provide additional detail regarding the operation of combiner 318 (which was introduced in FIG. 3A).

For example, combiner 802 may combine peak map 312 and depth-based mask 316 to generate combined mask 806. Peak map 312 may indicate peak amplitude values (e.g., which may be indicative of an accurate depth value of a spot). Depth-based mask 316 may indicate valid or invalid depth values. Combined mask 806, based on peak map 312 and depth-based mask 316 may indicate valid peak values.

Masker 804 may apply combined mask 806 to depth values 304 to generate refined depth values 308. Refined depth values 308 may include depth values that are valid and that correspond to peak amplitude values.

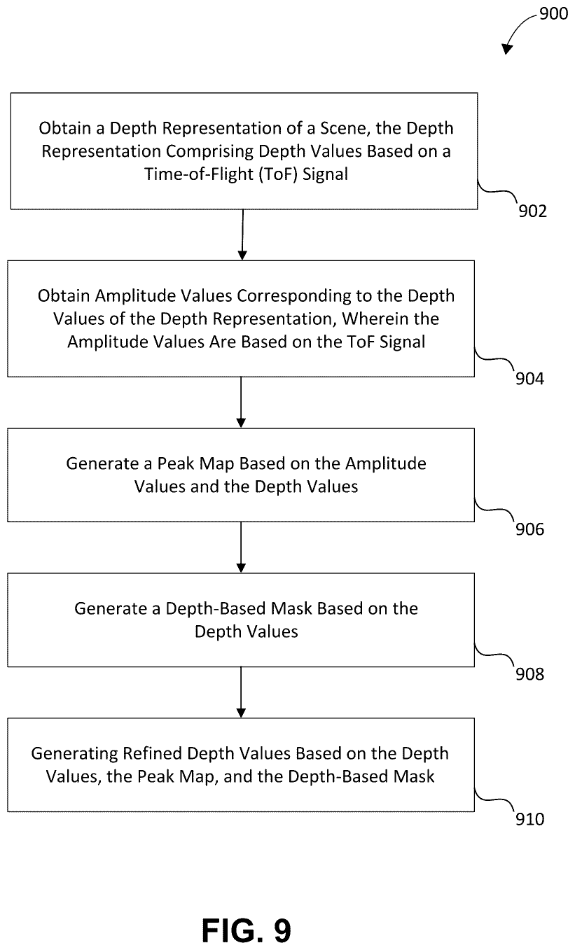

FIG. 9 is a flow diagram illustrating a process 900 for refining depth values, in accordance with aspects of the present disclosure. One or more operations of process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 900. The one or more operations of process 900 may be implemented as software components that are executed and run on one or more processors.

At block 902, a computing device (or one or more components thereof) may obtain a depth representation of a scene, the depth representation comprising depth values based on a time-of-flight (ToF) signal. For example, spot detector 306 of system 300 of FIG. 3 may obtain depth values 304. Depth values 304 may be based on a reflection of a ToF signal (or various ToF signals) from various points in a scene (e.g., the scene illustrated by image 320).

In some aspects, the depth representation of the scene may be based on a sparse ToF projection. For example, depth values 304 may be based on a sparse IToF projection. In some aspects, the computing device (or one or more components thereof) may cause a projector to project a pattern of spots into the scene, wherein the pattern of spots includes fewer spots than the depth representation includes depth values.

At block 904, the computing device (or one or more components thereof) may obtain amplitude values corresponding to the depth values of the depth representation, wherein the amplitude values are based on the ToF signal. For example, spot detector 306 of system 300 of FIG. 3 may obtain amplitude values 302. Amplitude values 302 may be based on a reflection of a ToF signal (or various ToF signals) from various points in a scene (e.g., the scene illustrated by image 320). Depth values 304 may be based on a timing of the ToF signal (e.g., a timing between emission and reflection of the ToF signal). Amplitude values 302 may be based on an amplitude of the ToF signal (e.g., an amplitude of the reflected ToF signal).

At block 906, the computing device (or one or more components thereof) may generate a peak map based on the amplitude values and the depth values. For example, local amplitude peak detector 310 of spot detector 306 may generate peak map 312 based on amplitude values 302 and depth values 304.

In some aspects, to generate the peak map, the computing device (or one or more components thereof) may apply a filter to the amplitude values to generate filtered amplitude values; and generate the peak map based on the filtered amplitude values. For example, local amplitude peak detector 310 may apply filter 402 of FIG. 4 to amplitude values 302 to generate filtered amplitude values 404.

In some aspects, to generating the peak map, the computing device (or one or more components thereof) may determine a plurality of peaks of a plurality of windows of the amplitude values, the plurality of peaks including a respective peak of each window of the plurality of windows, wherein a peak of a window of amplitude values comprises a greatest amplitude value of the window of amplitude values; and generate the peak map based on the plurality of peaks. For example, peak identifier 502 of FIG. 5 may determine peaks of each amplitude windows 506 of filtered amplitude values 404. Peak detector 406 may generate amplitude-based map 408 based on the peaks of amplitude windows 506 of filtered amplitude values 404.

In some aspects, wherein, to generate the peak map, the computing device (or one or more components thereof) may determine whether respective amplitude values of each window of a plurality of windows satisfy a window-amplitude criterion; and generate the peak map based on windows of the plurality of windows that include respective amplitude values that satisfy the window-amplitude criterion. For example, window checker 504 of FIG. 5 may determine whether amplitude values of each amplitude windows 506 of filtered amplitude values 404 satisfy a window-amplitude criterion. Peak detector 406 may generate amplitude-based map 408 based on amplitude windows 506 that include amplitude values that satisfy the window-amplitude criterion.

In some aspects, to generate the peak map, the computing device (or one or more components thereof) may determine whether respective amplitude values of each window of a plurality of windows satisfy a window-amplitude criterion; for each window of the plurality of windows that includes respective amplitude values that satisfy the window-amplitude criterion, determine a respective peak value, wherein a peak of a window of amplitude values comprises a greatest amplitude value of the window of amplitude values; and responsive to the amplitude values of a window of the plurality of windows satisfying the window-amplitude criterion, annotate as valid a pixel of the peak map, wherein the pixel corresponds to the peak of the window. For example, window checker 504 of FIG. 5 may determine whether amplitude values of each of amplitude windows 506 satisfy a window-amplitude criterion. For each of amplitude windows 506 that includes amplitude values that satisfy the window-amplitude criterion, peak identifier 502 may determine a respective peak value of the amplitude window 506. Responsive to the amplitude values of one of amplitude windows 506 satisfying the window-amplitude criterion, peak detector 406 may annotate as valid a pixel of amplitude-based map 408. The pixel may correspond to the peak of the window.

In some aspects, to generate the peak map, the computing device (or one or more components thereof) may generate a depth-threshold-based mask based on the depth values and a depth threshold; and generate the peak map based on the depth-threshold-based mask. For example, depth-based screener 414 of FIG. 4A may generate depth-threshold-based mask 416 and local amplitude peak detector 310 may generate peak map 420 based on amplitude-based map 408 and depth-threshold-based mask 416.

In some aspects, to generate the peak map, the computing device (or one or more components thereof) may determine a plurality of amplitude-based depth thresholds, wherein the plurality of amplitude-based depth thresholds comprises, for each depth value, a respective amplitude-based depth threshold based on an amplitude value corresponding to the depth value and a relationship between depth and amplitude; generate an amplitude-and-depth-based mask based on the depth values and the plurality of amplitude-based depth thresholds; and generate the peak map based on the amplitude-and-depth-based mask. For example, amplitude-and-depth-based screener 410 of FIG. 4A may generate amplitude-and-depth-based mask 412. Amplitude-and-depth-based mask 412 may include a depth threshold based on a corresponding amplitude value. For example, amplitude-and-depth-based mask 412 may indicate which of depth values 304 are invalid based on the invalid ones of depth values 304 exceeding a threshold that is based on corresponding ones of filtered amplitude values 404. Local amplitude peak detector 310 may generate peak map 420 based on amplitude-and-depth-based mask 412.

In some aspects, to generate the peak map, the computing device (or one or more components thereof) may generate an amplitude-based map based on the amplitude values; generate depth-threshold-based mask based on the depth values; generate an amplitude-and-depth-based mask based on the depth values and the amplitude values; and/or generate the peak map based on the amplitude-based map, the depth-threshold-based mask, and the amplitude-and-depth-based mask. For example, local amplitude peak detector 310 of FIG. 4A may generate amplitude-based map 408 based on amplitude values 302, generate depth-threshold-based mask 416 based on depth values 304, generates 412/based on filtered amplitude values 404 and depth values 304, and/or generate peak map 420 based on amplitude-based map 408, depth-threshold-based mask 416, and/or amplitude-and-depth-based mask 412.

In some aspects, to generate the peak map, the computing device (or one or more components thereof) may cause each window of a plurality of windows of the peak map to include no more than one peak. For example, spot checker 422 of FIG. 6 may generate peak map 312 based on peak map 420, for example, by causing peak map 312 to include no more than one peak per window 602.

At block 908, the computing device (or one or more components thereof) may generate a depth-based mask based on the depth values. For example, depth noise analyzer 314 of spot detector 306 may generate depth-based mask 316 based on depth values 304.

In some aspects, to generate the depth-based mask, the computing device (or one or more components thereof) may determine a plurality of depth-consistency criteria, wherein the plurality of depth-consistency criteria comprises a respective depth-consistency criterion for each depth value based on the depth value; and generate the depth-based mask based on the depth values and the plurality of depth-consistency criteria. For example, depth noise analyzer 314 of FIG. 7 may determine depth-consistency criterion 704 and generate depth-based mask 316 based on depth-consistency criterion 704.

In some aspects, to generate the depth-based mask, the computing device (or one or more components thereof) may identify a candidate depth value based on a relationship between the candidate depth value and depth values of a window around the candidate depth value; and annotate as valid a pixel of the depth-based mask, wherein the pixel corresponds to the candidate depth value. For example, depth noise analyzer 314 of FIG. 7 may determine a depth value C as a candidate depth values of given depth window 708 based on a relationship between depth value C and other depth values i of given depth window 708 (e.g., based on how many of depth values i are within a depth-consistency criterion 704 from depth value C). Depth noise analyzer 314 may annotate as valid a pixel of depth-based mask 316 that corresponds to depth value C.

At block 910, the computing device (or one or more components thereof) may generate refined depth values based on the depth values, the peak map, and the depth-based mask. For example, spot detector 306 may generate refined depth values 308 based on depth values 304, peak map 312, and depth-based mask 316.

In some aspects, to generate the refined depth values, the computing device (or one or more components thereof) may generate a combined mask based on the peak map and the depth-based mask; and apply the combined mask to the depth values to generate the refined depth values. For example, combiner 318 of FIG. 8 may generate combined mask 806 based on peak map 312 and depth-based mask 316 and apply combined mask 806 to depth values 304 to generate refined depth values 308.

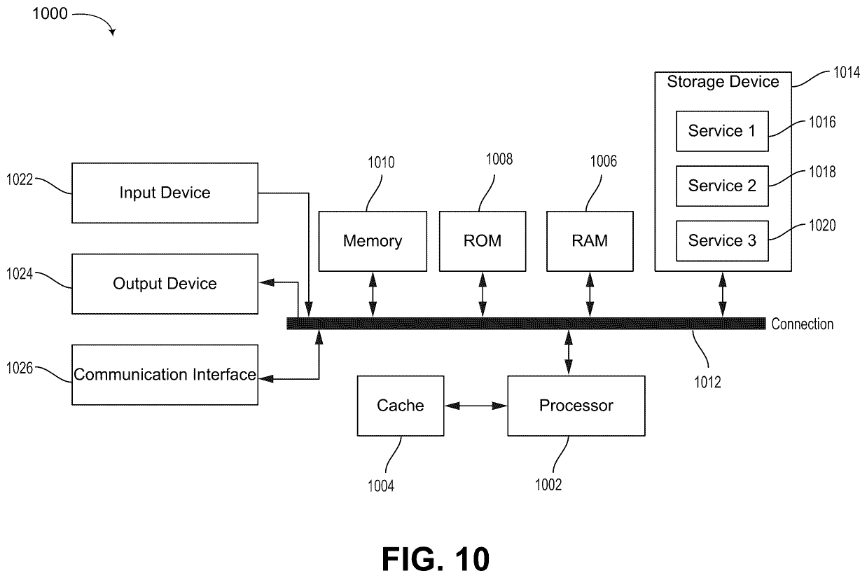

In some examples, as noted previously, the methods described herein (e.g., process 900 of FIG. 9, and/or other methods described herein) can be performed, in whole or in part, by a computing device or apparatus. In one example, one or more of the methods can be performed by sparse ToF depth camera 200 of FIG. 2, system 300 of FIG. 3A, FIG. 3B, of FIG. 8, or by another system or device. In another example, one or more of the methods (e.g., process 900 of FIG. 9, and/or other methods described herein) can be performed, in whole or in part, by the computing-device architecture 1000 shown in FIG. 10. For instance, a computing device with the computing-device architecture 1000 shown in FIG. 10 can include, or be included in, the components of the sparse ToF depth camera 200 and/or system 300, and can implement the operations of process 900, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 900, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 900, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 10 illustrates an example computing-device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1000 may include, implement, or be included in any or all of sparse ToF depth camera 200 of FIG. 2, system 300 of FIG. 3A, FIG. 3B, and/or FIG. 8. Additionally or alternatively, computing-device architecture 1000 may be configured to perform process 900, and/or other process described herein.

The components of computing-device architecture 1000 are shown in electrical communication with each other using connection 1012, such as a bus. The example computing-device architecture 1000 includes a processing unit (CPU or processor) 1002 and computing device connection 1012 that couples various computing device components including computing device memory 1010, such as read only memory (ROM) 1008 and random-access memory (RAM) 1006, to processor 1002.

Computing-device architecture 1000 can include a cache of high-speed memory connected directly with, in close proximity to, or integrated as part of processor 1002. Computing-device architecture 1000 can copy data from memory 1010 and/or the storage device 1014 to cache 1004 for quick access by processor 1002. In this way, the cache can provide a performance boost that avoids processor 1002 delays while waiting for data. These and other modules can control or be configured to control processor 1002 to perform various actions. Other computing device memory 1010 may be available for use as well. Memory 1010 can include multiple different types of memory with different performance characteristics. Processor 1002 can include any general-purpose processor and a hardware or software service, such as service 1 1016, service 2 1018, and service 3 1020 stored in storage device 1014, configured to control processor 1002 as well as a special-purpose processor where software instructions are incorporated into the processor design. Processor 1002 may be a self-contained system, containing multiple cores or processors, a bus, memory controller, cache, etc. A multi-core processor may be symmetric or asymmetric.

To enable user interaction with the computing-device architecture 1000, input device 1022 can represent any number of input mechanisms, such as a microphone for speech, a touch-sensitive screen for gesture or graphical input, keyboard, mouse, motion input, speech and so forth. Output device 1024 can also be one or more of a number of output mechanisms known to those of skill in the art, such as a display, projector, television, speaker device, etc. In some instances, multimodal computing devices can enable a user to provide multiple types of input to communicate with computing-device architecture 1000. Communication interface 1026 can generally govern and manage the user input and computing device output. There is no restriction on operating on any particular hardware arrangement and therefore the basic features here may easily be substituted for improved hardware or firmware arrangements as they are developed.

Storage device 1014 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1006, read only memory (ROM) 1008, and hybrids thereof. Storage device 1014 can include services 1016, 1018, and 1020 for controlling processor 1002. Other hardware or software modules are contemplated. Storage device 1014 can be connected to the computing device connection 1012. In one aspect, a hardware module that performs a particular function can include the software component stored in a computer-readable medium in connection with the necessary hardware components, such as processor 1002, connection 1012, output device 1024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for refining depth values, the apparatus comprising: at least one memory; and at least one processor coupled to the at least one memory and configured to: obtain a depth representation of a scene, the depth representation comprising depth values based on a time-of-flight (ToF) signal; obtain amplitude values corresponding to the depth values of the depth representation, wherein the amplitude values are based on the ToF signal; generate a peak map based on the amplitude values and the depth values; generate a depth-based mask based on the depth values; and generate refined depth values based on the depth values, the peak map, and the depth-based mask.

Aspect 2. The apparatus of aspect 1, wherein, to generate the peak map, the at least one processor is configured to: apply a filter to the amplitude values to generate filtered amplitude values; and generate the peak map based on the filtered amplitude values.

Aspect 3. The apparatus of any one of aspects 1 or 2, wherein, to generating the peak map, the at least one processor is configured to: determine a plurality of peaks of a plurality of windows of the amplitude values, the plurality of peaks including a respective peak of each window of the plurality of windows, wherein a peak of a window of amplitude values comprises a greatest amplitude value of the window of amplitude values; and generate the peak map based on the plurality of peaks.

Aspect 4. The apparatus of any one of aspects 1 to 3, wherein, to generate the peak map, the at least one processor is configured to: determine whether respective amplitude values of each window of a plurality of windows satisfy a window-amplitude criterion; and generate the peak map based on windows of the plurality of windows that include respective amplitude values that satisfy the window-amplitude criterion.

Aspect 5. The apparatus of any one of aspects 1 to 4, wherein, to generate the peak map, the at least one processor is configured to: determine whether respective amplitude values of each window of a plurality of windows satisfy a window-amplitude criterion; for each window of the plurality of windows that includes respective amplitude values that satisfy the window-amplitude criterion, determine a respective peak value, wherein a peak of a window of amplitude values comprises a greatest amplitude value of the window of amplitude values; and responsive to the amplitude values of a window of the plurality of windows satisfying the window-amplitude criterion, annotate as valid a pixel of the peak map, wherein the pixel corresponds to the peak of the window.

Aspect 6. The apparatus of any one of aspects 1 to 5, wherein, to generate the peak map, the at least one processor is configured to: generate a depth-threshold-based mask based on the depth values and a depth threshold; and generate the peak map based on the depth-threshold-based mask.

Aspect 7. The apparatus of any one of aspects 1 to 6, wherein, to generate the peak map, the at least one processor is configured to: determine a plurality of amplitude-based depth thresholds, wherein the plurality of amplitude-based depth thresholds comprises, for each depth value, a respective amplitude-based depth threshold based on an amplitude value corresponding to the depth value and a relationship between depth and amplitude; generate an amplitude-and-depth-based mask based on the depth values and the plurality of amplitude-based depth thresholds; and generate the peak map based on the amplitude-and-depth-based mask.

Aspect 8. The apparatus of any one of aspects 1 to 7, wherein, to generate the peak map, the at least one processor is configured to: generate an amplitude-based map based on the amplitude values; generate depth-threshold-based mask based on the depth values; generate an amplitude-and-depth-based mask based on the depth values and the amplitude values; and generate the peak map based on the amplitude-based map, the depth-threshold-based mask, and the amplitude-and-depth-based mask.

Aspect 9. The apparatus of any one of aspects 1 to 8, wherein, to generate the peak map, the at least one processor is configured to cause each window of a plurality of windows of the peak map to include no more than one peak.

Aspect 10. The apparatus of any one of aspects 1 to 9, wherein, to generate the depth-based mask, the at least one processor is configured to: determine a plurality of depth-consistency criteria, wherein the plurality of depth-consistency criteria comprises a respective depth-consistency criterion for each depth value based on the depth value; and generate the depth-based mask based on the depth values and the plurality of depth-consistency criteria.

Aspect 11. The apparatus of any one of aspects 1 to 10, wherein, to generate the depth-based mask, the at least one processor is configured to: identify a candidate depth value based on a relationship between the candidate depth value and depth values of a window around the candidate depth value; and annotate as valid a pixel of the depth-based mask, wherein the pixel corresponds to the candidate depth value.

Aspect 12. The apparatus of any one of aspects 1 to 11, wherein, to generate the depth-based mask, the at least one processor is configured to: identify a candidate depth value based on a count of depth values of a window around the candidate depth value that are within a depth-consistency criterion from the candidate depth value; and annotate as valid a pixel of the depth-based mask, wherein the pixel corresponds to the candidate depth value.

Aspect 13. The apparatus of any one of aspects 1 to 12, wherein, to generate the refined depth values, the at least one processor is configured to: generating a combined mask based on the peak map and the depth-based mask; and applying the combined mask to the depth values to generate the refined depth values.

Aspect 14. The apparatus of any one of aspects 1 to 13, wherein the depth representation of the scene is based on a sparse ToF projection.

Aspect 15. The apparatus of any one of aspects 1 to 14, wherein the at least one processor is further configured to cause a projector to project a pattern of spots into the scene, wherein the pattern of spots includes fewer spots than the depth representation includes depth values.

Aspect 16. A method for refining depth values, the method comprising: obtaining a depth representation of a scene, the depth representation comprising depth values based on a time-of-flight (ToF) signal; obtaining amplitude values corresponding to the depth values of the depth representation, wherein the amplitude values are based on the ToF signal; generating a peak map based on the amplitude values and the depth values; generating a depth-based mask based on the depth values; and generating refined depth values based on the depth values, the peak map, and the depth-based mask.

Aspect 17. The method of aspect 16, wherein generating the peak map comprises: applying a filter to the amplitude values to generate filtered amplitude values; and generating the peak map based on the filtered amplitude values.

Aspect 18. The method of any one of aspects 16 or 17, wherein generating the peak map comprises: determining a plurality of peaks of a plurality of windows of the amplitude values, the plurality of peaks including a respective peak of each window of the plurality of windows, wherein a peak of a window of amplitude values comprises a greatest amplitude value of the window of amplitude values; and generating the peak map based on the plurality of peaks.

Aspect 19. The method of any one of aspects 16 to 18, wherein generating the peak map comprises: determining whether respective amplitude values of each window of a plurality of windows satisfy a window-amplitude criterion; and generating the peak map based on windows of the plurality of windows that include respective amplitude values that satisfy the window-amplitude criterion.

Aspect 20. The method of any one of aspects 16 to 19, wherein generating the peak map comprises: determining whether respective amplitude values of each window of a plurality of windows satisfy a window-amplitude criterion; for each window of the plurality of windows that includes respective amplitude values that satisfy the window-amplitude criterion, determining a respective peak value, wherein a peak of a window of amplitude values comprises a greatest amplitude value of the window of amplitude values; and responsive to the amplitude values of a window of the plurality of windows satisfying the window-amplitude criterion, annotating as valid a pixel of the peak map, wherein the pixel corresponds to the peak of the window.

Aspect 21. The method of any one of aspects 16 to 20, wherein generating the peak map comprises: generating a depth-threshold-based mask based on the depth values and a depth threshold; and generating the peak map based on the depth-threshold-based mask.

Aspect 22. The method of any one of aspects 16 to 21, wherein generating the peak map comprises: determining a plurality of amplitude-based depth thresholds, wherein the plurality of amplitude-based depth thresholds comprises, for each depth value, a respective amplitude-based depth threshold based on an amplitude value corresponding to the depth value and a relationship between depth and amplitude; generating an amplitude-and-depth-based mask based on the depth values and the plurality of amplitude-based depth thresholds; and generating the peak map based on the amplitude-and-depth-based mask.

Aspect 23. The method of any one of aspects 16 to 22, wherein generating the peak map comprises: generating an amplitude-based map based on the amplitude values; generating depth-threshold-based mask based on the depth values; generating an amplitude-and-depth-based mask based on the depth values and the amplitude values; and generating the peak map based on the amplitude-based map, the depth-threshold-based mask, and the amplitude-and-depth-based mask.

Aspect 24. The method of any one of aspects 16 to 23, wherein generating the peak map comprises causing each window of a plurality of windows of the peak map to include no more than one peak.

Aspect 25. The method of any one of aspects 16 to 24, wherein generating the depth-based mask comprises: determining a plurality of depth-consistency criteria, wherein the plurality of depth-consistency criteria comprises a respective depth-consistency criterion for each depth value based on the depth value; and generating the depth-based mask based on the depth values and the plurality of depth-consistency criteria.

Aspect 26. The method of any one of aspects 16 to 25, wherein generating the depth-based mask comprises: identifying a candidate depth value based on a relationship between the candidate depth value and depth values of a window around the candidate depth value; and annotating as valid a pixel of the depth-based mask, wherein the pixel corresponds to the candidate depth value.

Aspect 27. The method of any one of aspects 16 to 26, wherein generating the depth-based mask comprises: identifying a candidate depth value based on a count of depth values of a window around the candidate depth value that are within a depth-consistency criterion from the candidate depth value; and annotating as valid a pixel of the depth-based mask, wherein the pixel corresponds to the candidate depth value.

Aspect 28. The method of any one of aspects 16 to 27, wherein generating the refined depth values comprises: generating a combined mask based on the peak map and the depth-based mask; and applying the combined mask to the depth values to generate the refined depth values.

Aspect 29. The method of any one of aspects 16 to 28, wherein the depth representation of the scene is based on a sparse ToF projection.

Aspect 30. The method of any one of aspects 16 to 29, further comprising causing a projector to project a pattern of spots into the scene, wherein the pattern of spots includes fewer spots than the depth representation includes depth values.

Aspect 31. A non-transitory computer-readable storage medium having stored thereon instructions that, when executed by at least one processor, cause the at least one processor to perform operations according to any of aspects 16 to 30.

Aspect 32. An apparatus for providing virtual content for display, the apparatus comprising one or more means for perform operations according to any of aspects 16 to 30.

What is claimed is:

1. An apparatus for refining depth values, the apparatus comprising:
at least one memory; and
at least one processor coupled to the at least one memory and configured to:
obtain a depth representation of a scene, the depth representation comprising depth values based on a time-of-flight (ToF) signal;
obtain amplitude values corresponding to the depth values of the depth representation, wherein the amplitude values are based on the ToF signal;
generate a peak map based on the amplitude values and the depth values;
generate a depth-based mask based on the depth values; and
generate refined depth values based on the depth values, the peak map, and the depth-based mask.

2. The apparatus of claim 1, wherein, to generate the peak map, the at least one processor is configured to:
apply a filter to the amplitude values to generate filtered amplitude values; and
generate the peak map based on the filtered amplitude values.

3. The apparatus of claim 1, wherein, to generating the peak map, the at least one processor is configured to:
determine a plurality of peaks of a plurality of windows of the amplitude values, the plurality of peaks including a respective peak of each window of the plurality of windows, wherein a peak of a window of amplitude values comprises a greatest amplitude value of the window of amplitude values; and
generate the peak map based on the plurality of peaks.

4. The apparatus of claim 1, wherein, to generate the peak map, the at least one processor is configured to:
determine whether respective amplitude values of each window of a plurality of windows satisfy a window-amplitude criterion; and
generate the peak map based on windows of the plurality of windows that include respective amplitude values that satisfy the window-amplitude criterion.

5. The apparatus of claim 1, wherein, to generate the peak map, the at least one processor is configured to:
determine whether respective amplitude values of each window of a plurality of windows satisfy a window-amplitude criterion;
for each window of the plurality of windows that includes respective amplitude values that satisfy the window-amplitude criterion, determine a respective peak value, wherein a peak of a window of amplitude values comprises a greatest amplitude value of the window of amplitude values; and
responsive to the amplitude values of a window of the plurality of windows satisfying the window-amplitude criterion, annotate as valid a pixel of the peak map, wherein the pixel corresponds to the peak of the window.

6. The apparatus of claim 1, wherein, to generate the peak map, the at least one processor is configured to:
generate a depth-threshold-based mask based on the depth values and a depth threshold; and
generate the peak map based on the depth-threshold-based mask.

7. The apparatus of claim 1, wherein, to generate the peak map, the at least one processor is configured to:
determine a plurality of amplitude-based depth thresholds, wherein the plurality of amplitude-based depth thresholds comprises, for each depth value, a respective amplitude-based depth threshold based on an amplitude value corresponding to the depth value and a relationship between depth and amplitude;
generate an amplitude-and-depth-based mask based on the depth values and the plurality of amplitude-based depth thresholds; and
generate the peak map based on the amplitude-and-depth-based mask.

8. The apparatus of claim 1, wherein, to generate the peak map, the at least one processor is configured to:
generate an amplitude-based map based on the amplitude values;
generate depth-threshold-based mask based on the depth values;
generate an amplitude-and-depth-based mask based on the depth values and the amplitude values; and
generate the peak map based on the amplitude-based map, the depth-threshold-based mask, and the amplitude-and-depth-based mask.

9. The apparatus of claim 1, wherein, to generate the peak map, the at least one processor is configured to cause each window of a plurality of windows of the peak map to include no more than one peak.

10. The apparatus of claim 1, wherein, to generate the depth-based mask, the at least one processor is configured to:
determine a plurality of depth-consistency criteria, wherein the plurality of depth-consistency criteria comprises a respective depth-consistency criterion for each depth value based on the depth value; and
generate the depth-based mask based on the depth values and the plurality of depth-consistency criteria.

11. The apparatus of claim 1, wherein, to generate the depth-based mask, the at least one processor is configured to:
identify a candidate depth value based on a relationship between the candidate depth value and depth values of a window around the candidate depth value; and
annotate as valid a pixel of the depth-based mask, wherein the pixel corresponds to the candidate depth value.

12. The apparatus of claim 1, wherein, to generate the depth-based mask, the at least one processor is configured to:
identify a candidate depth value based on a count of depth values of a window around the candidate depth value that are within a depth-consistency criterion from the candidate depth value; and
annotate as valid a pixel of the depth-based mask, wherein the pixel corresponds to the candidate depth value.

13. The apparatus of claim 1, wherein, to generate the refined depth values, the at least one processor is configured to:
generating a combined mask based on the peak map and the depth-based mask; and
applying the combined mask to the depth values to generate the refined depth values.

14. The apparatus of claim 1, wherein the depth representation of the scene is based on a sparse ToF projection.

15. The apparatus of claim 1, wherein the at least one processor is further configured to cause a projector to project a pattern of spots into the scene, wherein the pattern of spots includes fewer spots than the depth representation includes depth values.

16. A method for refining depth values, the method comprising:
obtaining a depth representation of a scene, the depth representation comprising depth values based on a time-of-flight (ToF) signal;
obtaining amplitude values corresponding to the depth values of the depth representation, wherein the amplitude values are based on the ToF signal;
generating a peak map based on the amplitude values and the depth values;
generating a depth-based mask based on the depth values; and
generating refined depth values based on the depth values, the peak map, and the depth-based mask.

17. The method of claim 16, wherein generating the peak map comprises:
applying a filter to the amplitude values to generate filtered amplitude values; and
generating the peak map based on the filtered amplitude values.

18. The method of claim 16, wherein generating the peak map comprises:
determining a plurality of peaks of a plurality of windows of the amplitude values, the plurality of peaks including a respective peak of each window of the plurality of windows, wherein a peak of a window of amplitude values comprises a greatest amplitude value of the window of amplitude values; and
generating the peak map based on the plurality of peaks.

19. The method of claim 16, wherein generating the peak map comprises:
determining whether respective amplitude values of each window of a plurality of windows satisfy a window-amplitude criterion; and
generating the peak map based on windows of the plurality of windows that include respective amplitude values that satisfy the window-amplitude criterion.

20. The method of claim 16, wherein generating the peak map comprises:
determining whether respective amplitude values of each window of a plurality of windows satisfy a window-amplitude criterion;
for each window of the plurality of windows that includes respective amplitude values that satisfy the window-amplitude criterion, determining a respective peak value, wherein a peak of a window of amplitude values comprises a greatest amplitude value of the window of amplitude values; and
responsive to the amplitude values of a window of the plurality of windows satisfying the window-amplitude criterion, annotating as valid a pixel of the peak map, wherein the pixel corresponds to the peak of the window.
